(19) United States
(12) Patent Application Publication
(10) Pub. No.: US 2016/0268942 A1
(43) Pub. Date: Sep. 15, 2016

(54) Control of Hybrid Permanent Magnet Machine With Rotating Power Converter and Energy Source

(71) Applicant: Hamilton Sundstrand Corporation, Charlotte, NC (US)

(72) Inventors: Gregory I. Rozman, Rockford, IL (US); Jacek F. Gieras, Glastonbury, CT (US); Steven J. Moss, Rockford, IL (US)

(21) Appl. No.: 14/645,471

(22) Filed: Mar. 12, 2015

(51) Int. Cl. H02P 9/30; H02K 21/04; H02K 1/27; H02K 11/00; H02K 11/04

(52) U.S. Cl. CPC H02P 9/302; H02K 11/0073; H02K 11/0094; H02K 11/042; H02K 1/272; H02K 21/042

(57) ABSTRACT

A hybrid permanent magnet machine has a stator including armature windings. A rotor includes permanent magnets, a main field winding, and a rechargeable energy source. An output voltage control circuit, including an H bridge circuit configured to provide control current magnitude and direction in the main field winding to control the current passing across the main field windings.

### BACKGROUND OF THE INVENTION

This application relates to a control for an electric machine having both wound coils and permanent magnets on its rotor and wherein an output voltage is controlled with a rotating energy source.

Electric machines are known. Two typical applications of an electric machine may be operation as a motor, in which a current is passed through a stator to cause a rotor to rotate. The rotor rotates a shaft to, in turn, rotate a component.

Another typical application is a generator. In a generator application, a source of rotation drives the shaft to drive the rotor and this generates current in the stator.

Two general types of rotors are known. A wound field rotor has coils to pass current. When only the wound coils are utilized, the resultant machine requires a relatively large synchronous exciter.

Another type of machine utilizes a permanent magnet motor. However, a permanent magnet rotor cannot supply constant voltage over operating speed and load variation.

Hybrid rotors are known which utilize both coils and permanent magnets. However, the control of such machines is not well developed.

Another challenge with hybrid rotors is that at fault conditions continued rotation of the permanent magnets will result in some continuing generation of power, which is undesirable, particularly, in aircraft operation.

### SUMMARY OF THE INVENTION

A hybrid permanent magnet machine has a stator including armature windings. A rotor includes permanent magnets, a main field winding, and a rechargeable energy source. An output voltage control circuit, including an H bridge circuit configured to provide control current magnitude and direction in the main field winding to control the current passing across the main field windings.

These and other features may be best understood from the following drawings and specification.

### BRIEF DESCRIPTION OF THE DRAWINGS

FIG. 1 shows a hybrid machine.

FIG. 2 shows a first control circuit.

FIG. 3 shows an alternative control circuit.

FIG. 4 shows yet another alternative control circuit.

FIG. 5 shows yet another alternative control circuit.

### DETAILED DESCRIPTION

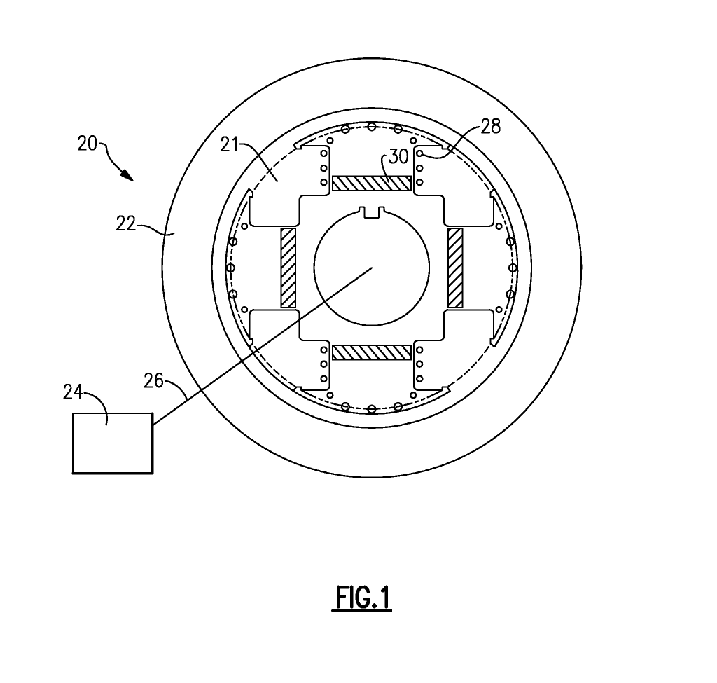

FIG. 1 shows a machine 20 including a rotor 21 rotating within a stator 22. A system 24 is associated with a machine 20 and connected to the rotor 21 by a shaft 26. If the associated system 24 is an item to be driven, then the machine 20 may be a motor. On the other hand, the associated system 24 could be a source of rotation, such as a gas turbine engine on an aircraft. In such applications, machine 20 may provide a starter motor function for the gas turbine engine 24. During operation of the gas turbine engine 24, the engine would drive the shaft 26 to cause the rotor 21 to rotate and generate electric current in the stator 22.

The rotor 21 is shown having electric coils 28, as well as permanent magnets 30.

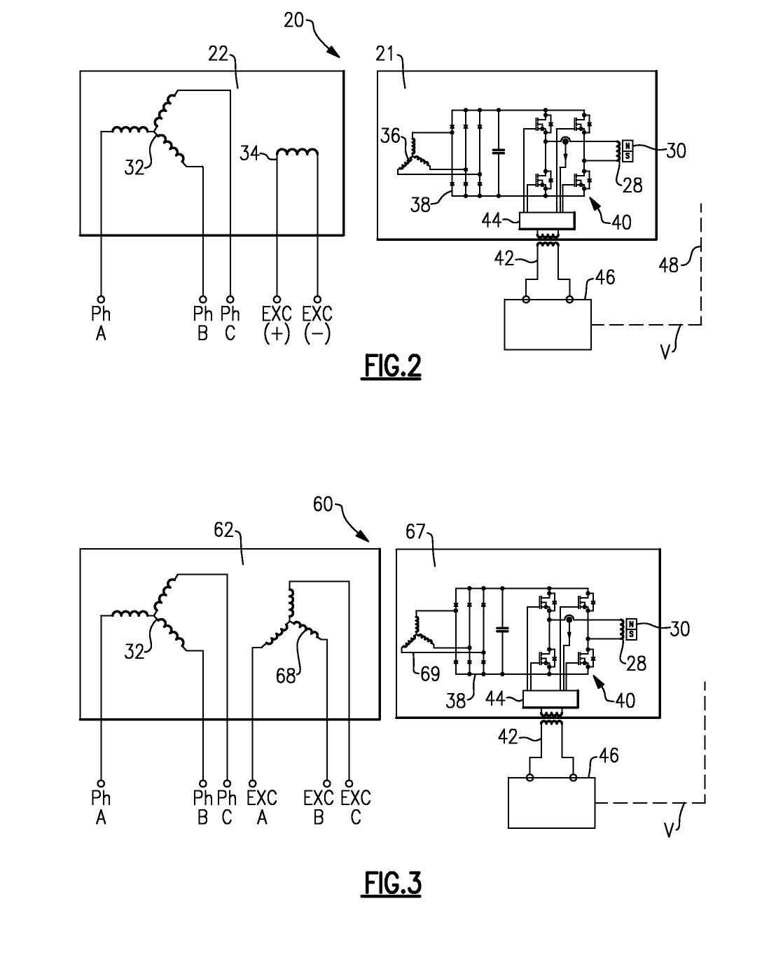

FIG. 2 is an electric circuit schematic for the machine 20. As shown, the stator 22 has stator armature windings 32 along with an exciter field winding 34. The stator armature windings communicate with main field windings 28. The exciter field winding 34 communicates with exciter armature windings 36. A rotating rectifier 38 converts the power received from the exciter armature windings and passes it across an H bridge 40 to control the current in the windings 28.

As known, an H bridge comprises four transistors and four diodes. By selectively opening and closing the transistors, current can flow in the same direction, or in an opposed direction, to the main field current in the windings 28. As also shown, a communication transformer 42 communicates with an encoder/decoder 44, which controls the H bridge 40. A main control 46 receives a signal 48 indicative of the voltage output of the machine 20. The control 46 operates the H bridge 40 to either increase or decrease the current passing across the windings 28 to achieve a desired voltage from the machine 20.

FIG. 3 shows an embodiment 60, which is similar to the embodiment of FIG. 2. However, the stator 62 has its stator armature windings 32 and also has a high frequency transformer primary winding 68. The rotor 67 is provided with high frequency transformer secondary windings 69. The rotor 67 is otherwise similar to the FIG. 2 rotor.

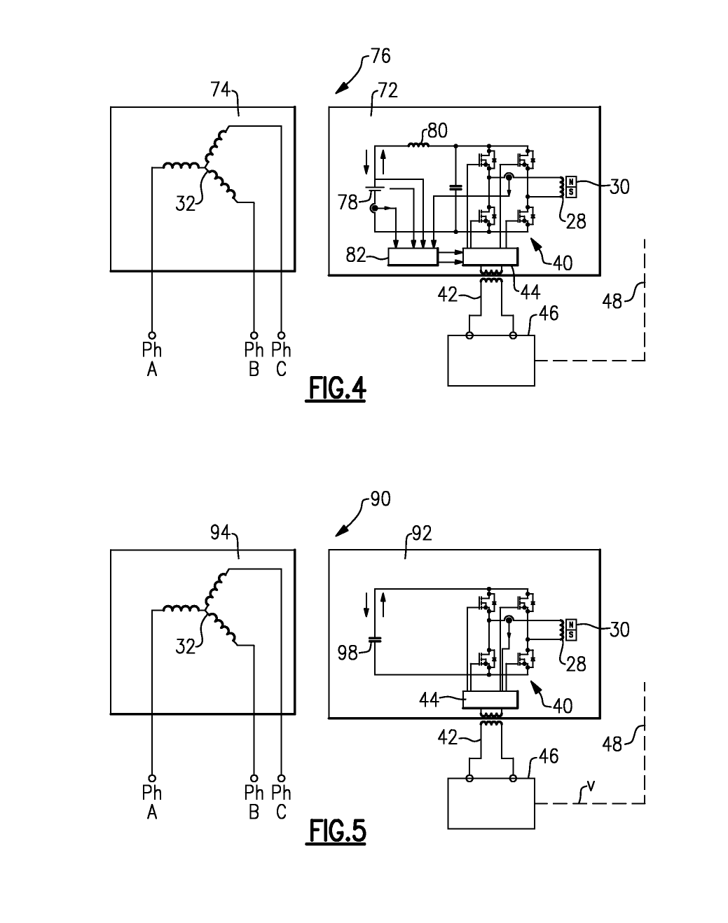

FIG. 4 shows an embodiment 70 having a rotor 72 and a stator 74. The stator armature windings 32 are illustrated. The control power at the rotor 72 is generated by a battery 78. Inductor 80 and a battery field monitor 82 are also illustrated. The battery field monitor 82 monitors the voltage and power from the battery along with its temperature. These are sent to the encoder/decoder 44 and may be utilized by the control 46.

FIG. 5 shows another embodiment 90 having a rotor 92 and a stator 94. Stator 94 is provided with a stator armature windings 32. Rotor 92 is provided with a super capacitor 98. During certain periods of operation, the capacitor 98 has its power dissipated to provide the control current.

The FIGS. 4 and 5 embodiments 70 and 90 utilize the stored power at the battery 78, or super capacitor 98 to provide the control voltage. During normal operation, power will flow from the battery 78 or super capacitor 98. However, when normal operation is stopped, a recharge mode may be entered at which power is supplied, such as from the stator armature windings 32, through the main field windings 28, and then back to battery 78 or super capacitor 98 to charge the items.

In each of the FIGS. 3-5, the H bridge 40 is controlled as the FIG. 2 embodiment to achieve a desired voltage. In addition, at fault condition, the control 46 can drive the output voltage to zero rapidly canceling the continuing effect of the rotating permanent magnets 30.

In essence, the main control 46 takes in the voltage signal 48, and compares it to a desired signal. If the voltage signal 48 is below that which is desired, then the H bridge will be controlled such that the power will flow in the same direction as that in the coils 28 to increase the output voltage. Alternatively, should the voltage sensed from the signal 48 be too high, the H bridge will be controlled such that current will flow in an opposed direction to that flowing through the coil 28, and the output voltage will then move downwardly. During fault conditions, it will likely be this flow in opposition to the current otherwise generated such as by the continued rotation of the permanent magnets 30 that will be utilized.

The overall system provides benefits reducing the weight and volume by utilizing a hybrid machine including both wound coils and permanent magnets, but also providing accurate control. The disclosed embodiments enable voltage regulation over large speed and load variation. As mentioned, the disclosed systems will allow rapid reduction of excitation to zero during a fault condition. Further, the system efficiency is improved due to reduced losses in the generator. The disclosed systems will also facilitate advance diagnostics and prognostics and add some level of intelligence to the system.

Although an embodiment of this invention has been disclosed, a worker of ordinary skill in this art would recognize that certain modifications would come within the scope of this invention. For that reason, the following claims should be studied to determine the true scope and content of this invention.

1. A hybrid permanent magnet machine comprising:
a stator including armature windings;
a rotor including permanent magnets and a main field winding;
a rechargeable energy source; and
an output voltage control circuit including an H bridge circuit configured to provide a control current magnitude and direction in the main field winding to control the current passing across the main field winding.

2. The hybrid machine as set forth in claim 1, wherein a control monitors voltage output and controls said H bridge upon said monitored voltage output.

3. The hybrid machine as set forth in claim 2, wherein said control being programmed to bring said output voltage toward zero in the event of a fault.

4. The hybrid machine as set forth in claim 2, wherein said control providing control signals to said rotor through a transformer communicating with an encoder/decoder on said rotor.

5. The hybrid permanent magnet machine as set forth in claim 1, wherein said stator further including an exciter field winding communicating with exciter armature windings on said rotor and said exciter armature windings being said rechargeable energy source.

6. The hybrid permanent magnet machine as set forth in claim 5, wherein a rotating rectifier converts power from said exciter armature windings passing toward said H bridge.

7. The hybrid permanent magnet machine as set forth in claim 1, wherein said stator includes a high frequency transformer primary winding and a high frequency transformer secondary winding is provided on said rotor and said high frequency transformer secondary winding being said rechargeable energy source.

8. The hybrid permanent magnet machine as set forth in claim 7, wherein a rotating rectifier converts power from said exciter armature windings passing toward said H bridge. The hybrid permanent magnet machine as set forth in claim 1, wherein said rechargeable energy source is a battery to supply power toward said H bridge and to receive power in a charge mode.

10. The hybrid permanent magnet machine as set forth in claim 9, wherein a separate charging mode is entered where said battery is recharged.

11. The hybrid permanent magnet machine as set forth in claim 1, wherein said rechargeable energy source is a capacitor mounted on said rotor and charged or dissipated.

12. The hybrid permanent magnet machine as set forth in claim 11, wherein a charging mode is entered where said capacitor is recharged.

13. A method of operating a hybrid permanent magnet machine comprising:
controlling a H bridge on a rotor to provide a desired current magnitude and direction from a rechargeable energy source on said rotor to a main field winding, such that a voltage output is moved toward a desired amount.

14. The method as set forth in claim 13, wherein said H bridge is controlled such that said control is in the same direction as a current across the main field winding if the monitored voltage is below a desired level, and is in an opposed direction if the monitored voltage is above a desired level.

15. The method as set forth in claim 13, wherein said control being programmed to bring said output voltage toward zero in the event of a fault.
